(19) United States
(12) Patent Application Publication
(10) Pub. No.: US 2025/0371421 A1
(43) Pub. Date: Dec. 4, 2025

(54) ADAPTION OF AGENTIC MODELS TO PRODUCTION ENVIRONMENT

(71) Applicant: NEC Laboratories America, Inc., Princeton, NJ (US)

(72) Inventors: Vijay Kumar Baikampady Gopalkrishna, San Jose, CA (US); Samuel Schulter, Long Island City, NY (US)

(21) Appl. No.: 19/219,200

(22) Filed: May 27, 2025

Related U.S. Application Data
(60) Provisional application No. 63/652,354, filed on May 28, 2024.

(51) Int. Cl. G06N 20/00; G06N 5/04

(52) U.S. Cl. CPC G06N 20/00; G06N 5/04

(57) ABSTRACT

Systems and methods for adapting an agentic artificial intelligence (AI) model is provided. The systems and methods include extracting embeddings of a user input and determining an execution time and input domain according to the embeddings of the user input. The systems and methods further include developing an inference plan according to the execution time and input domain, and selecting modules that satisfy the inference plan considering output accuracy and execution time to satisfy an execution time accuracy tradeoff.

### RELATED APPLICATION INFORMATION

This application claims priority to U.S. Provisional Patent Application 63/652,354, filed on May 28, 2024, incorporated herein by reference in its entirety.

### BACKGROUND

### Technical Field

The present invention relates to artificial intelligence model adaptation and more particularly, to systems and methods for adapting an artificial intelligence (AI) model for specific tasks by adjusting hyperparameters.

### Description of the Related Art

Conventional methods of fine-tuning artificial intelligence (AI) models for optimized performance include using a limited set of annotated (labeled) data from a target domain. Using supervised training can be impractical in some instances because of the potential for overfitting of data.

Furthermore, larger AI models yield higher (better) performance but operate more slowly than smaller models that are more efficient but lack the ability to capture complex patterns, leading to lower (worse) performance, while smaller models may be better suited for situations that are time sensitive, they are not necessarily as accurate.

Other limitations that AI models can include are an inability to train the AI model. Frozen AI models can be pretrained and the weights of the parameters cannot be modified for particular situations.

Furthermore, AI models can be optimized for syntactic and semantic correctness rather than functional correctness.

### SUMMARY

According to an aspect of the present invention, a method is provided for adapting an agentic artificial intelligence (AI) model. The method includes extracting embeddings of a user input and determining an execution time and input domain according to the embeddings of the user input. The method further includes developing an inference plan according to the execution time and input domain and selecting modules that satisfy the inference plan considering output accuracy and execution time to satisfy an execution time accuracy tradeoff.

According to another aspect of the present invention, a system is provided for adapting an agentic artificial intelligence (AI) model. The system includes a processor and a memory storing computer-readable instructions that. The memory, when executed by the processor, causes the system to extract embeddings of a user input and determine an execution time and input domain according to the embeddings of the user input. The memory can further cause the system to develop an inference plan according to the execution time and input domain and select modules that satisfy the inference plan considering output accuracy and execution time to satisfy an execution time accuracy tradeoff.

According to yet another aspect of the present invention, a computer program product including a non-transitory computer-readable storage medium containing computer program code is provided. The computer program code, when executed by one or more processors, causes the one or more processors to perform operations. The computer program code includes instructions to extract embeddings of a user input to an agentic artificial intelligence (AI) model and determine an execution time and input domain according to the embeddings of the user input. The computer program code further includes instructions to develop an inference plan according to the execution time and input domain and select modules that satisfy the inference plan considering output accuracy and execution time to satisfy an execution time accuracy tradeoff.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a framework for an AI model planner, in accordance with an embodiment of the present invention;

FIG. 2 is a block diagram illustrating variation in a hyperparameter, in accordance with an embodiment of the present invention;

FIG. 3 is a block diagram illustrating variation in modules, in accordance with an embodiment of the present invention;

FIG. 4 is a block diagram illustrating a Large Language Model (LLM) system, in accordance with an embodiment of the present invention;

FIG. 5 is block diagram showing a system illustrating an agentic textual-visual identification model planner, in accordance with an embodiment of the present invention;

FIG. 6 is a block diagram illustrating the system selecting modules for the agentic LLM, in accordance with an embodiment of the present invention;

FIG. 7 is a flow diagram illustrating a method for planning the modification of an agentic AI model, in accordance with an embodiment of the present invention;

FIG. 8 is a block diagram illustrating an exemplary processing system which can execute the agentic adaptive LLM, in accordance with an embodiment of the present invention; and

FIG. 9 is a block diagram of a neural network, in accordance with an embodiment of the present invention.

### DETAILED DESCRIPTION OF PREFERRED EMBODIMENTS

An agentic artificial intelligence (AI) model that can quickly adapt to, and optimize for a variety of different situations, has increased utility. By making minimal modifications to the AI model's parameters, hyperparameters, or adapting the AI model's modules in accordance with natural language descriptions to target new domains, an AI model can be used in situations that previously needed the use of multiple AI models. Some, if not all of these AI models may be specially trained for a particular purpose. In some embodiments of the present invention, the AI model can be a Large Language Model (LLM). Other forms of AI are also contemplated such as artificial neural networks (ANNs), natural language processing models (NLP), machine learning modes (ML), computer vision (CV), and autonomous vehicles, recommender systems, etc.

Many AI models can only function if the data that the AI model is testing or is prompted with during the inference stage is the same type of data as the data the AI model is trained on. This limitation can result in overfitting the data and artificially limiting the utility of the AI model. Overfitting can occur when the model matches (e.g. memorizes) the training set so closely that the model fails to make correct predictions on new, previously unseen, data.

For example, an AI model tasked with detecting houses that is only trained with images from a front view of houses can have difficulty identifying the same houses from aerial images. The front view and top (aerial) view of houses are different and show different features that can be mutually exclusive to one another. Front view images may have doors which are not available in top views and top view images may show features of chimneys, skylights, gutters, etc., not available in front views. These differences make models trained on one type of image incompatible with the other type of image. This domain gap can lead to overfitting of house recognition and low accuracy which consequently lowers image recognition capabilities. Ultimately, this can then lead the model to be unusable in many situations the model is otherwise intended to address and necessitate building other AI models to solve these problems piecemeal. Therefore, minimizing overfitting of AI models with an agentic model is imperative.

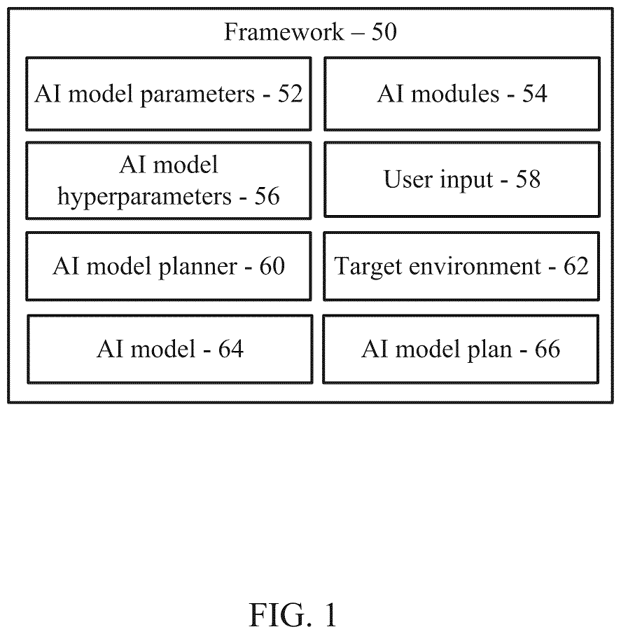

Referring now in detail to the figures in which like numerals represent the same or similar elements and initially to FIG. 1, FIG. 1 is a block diagram illustrating a framework 50 for an AI model planner 60. AI model planner 60 configures AI model 64. Framework 50 adapts AI model parameters 52, AI modules 54, or AI model hyperparameters 56 for a target environment (application) 62 or task. Target environment 62 can be identified through natural language descriptions of the environment. Since AI model 64 can be used in several target environments 62, embodiments of the present invention can increase AI model's 64 utility. In embodiments of the present invention, AI model 64 can be an LLM, computer vision (CV) model, autonomous driving model, robotics model, machine learning (ML) model, natural language processing (NLP) model, or other forms of artificial intelligence. The natural language descriptions can come from user input 58. Other embodiments of the present invention can include user inputs 58 that are natural language such as mathematical equations, programming languages, formal logic, regular expressions, markup language, diagrams and schematics, chemical notation, musical notation, mathematical logic, etc. User input 58 can also come from a computer or another source. In other words, framework 50 can receive instructions from a source other than directly from user input 58.

Additionally, since performance is inversely related to AI model 64 size, the relationship between AI model 64 size and performance is an important consideration in a given target environment 62. Providing the option to account for this consideration can be useful. Designing AI model planner 60 to be agentic and operate autonomously to tailor AI model 64 to a given target environment 62 can satisfy this consideration. For example, using AI model 64 for offering suggestions and recommendations related to tourism prefers real-time recommendations that are fast (to improve user-experience), but the accuracy of the response is less important since not every tourist has identical objectives and preferences. In contrast, driving scene analysis (such as training autonomous vehicle guidance models) or vehicle navigation, both of which can be performed offline or in less time sensitive situations, prefer accurate results that can be temporally and computationally expensive. AI model 64 can identify these differences and modify AI model hyperparameters 56 accordingly to improve the user experience. In other embodiments of the present invention, AI model planner 60 can select appropriate AI model modules 54 applying agentic principles according to the given target environment 62. AI model modules 54 can be defined as self-contained units that encapsulate a specific function, task, or abstraction. Examples of AI model modules 54 can include mathematical functions, operating system interfaces, temporary memory units, encapsulated sensors and corresponding software, embedded communications units, databases, user interfaces, payment processing systems, etc.

AI model planner 60 can identify domain (environment) gaps and adapt rapidly to new target environments 62 (e.g., new domains) through natural language descriptions of the environment. Additionally or alternatively, AI model planner 60 can adapt to a new situation by adjusting a minimal number of AI model's hyperparameters 56 for a given task and can increase the utility of AI model 64.

In an embodiment of the present invention, AI model 64 can use AI planner (orchestrator) 60 to generate an AI model plan 66 to accomplish tasks using the tools available and various pre-trained domain specific AI modules 54. AI model planner 60 can include several AI modules 54 for the same task and for different tasks. For example, AI modules 54 for the same task can include multiple object detectors with different architectures or trained with different data (e.g., identify aerial photos and street-view photos). AI modules 54 for different tasks can include modules for classification, segmentation, depth estimation, etc. These AI modules 54 can perform a variety of tasks including translating, analyzing sentiment, generating code, summarizing, holding conversations, answering questions, writing e-mails and other forms of text, etc.

In some embodiments of the present invention, AI model planner 60 has access to the documentation of each AI module 54 as well as AI model hyperparameters 56 (e.g. thresholds of a detector, thresholds of proposal generator, thresholds used for data augmentation) of AI modules 54. This access allows AI model planner 60 to change module thresholds (the characteristics of AI modules 54) or AI model hyperparameters 56 based on the natural language instruction (e.g., user input 58). AI modules 54 documentation includes information pertinent to the AI modules 54 such as execution time and accuracy.

The natural language instruction can be text, audio, or other forms of human language that can direct AI model 64. The natural language instruction can be a single sentence, thought, word, paragraph, or section. In other embodiments of the present invention, natural language instruction can be lengthy such as a book or essay. The natural language instruction can include a description that directs AI model 64 to the given target environment 62.

If a small dataset (with labels) from target environment 62 is available e.g., one hundred (100) images, then AI model 64 can be adapted for a given situation related to target environment 62 by tuning AI model hyperparameters 56 of AI model 64. Alternatively, other embodiments of the present invention can adapt data-augmentations and adapt AI model plan 66. In some embodiments of the present invention, adapting AI model hyperparameters 56 is beneficial because there are less AI model hyperparameters 56 than AI model 64 weights. Modifying AI model hyperparameters 56 therefore can reduce the likelihood of overfitting. AI model 64 can treat weights as AI model parameters 52 in some embodiments of the present invention.

AI model planner 60 can prevent overfitting in a variety of ways. In an embodiment of the present invention, AI model planner 60 can change AI model hyperparameters 56, e.g., threshold of AI modules 54 or data augmentations, by validating on a small data set from the target environment 62. Other embodiments can employ zero-shot or one-shot training. This provides AI model 64 with some degree of certainty that AI model 64 is appropriately acclimated to the present application without being too computationally or temporally expensive. In other embodiments of the present invention, AI model planner 60 can change the plans generated based on characteristics or metadata of the target data. In even further embodiments of the present invention, AI model planner 60 can prevent overfitting by selectively choosing AI modules 54 that are well suited for the target task where the characteristics of the target data are provided by a user in natural language form or from metadata. AI model planner 60 can utilize one or several of these embodiments simultaneously.

AI model planner 60 can also be employed in image recognition applications. In some embodiments of the present invention, the AI model 64 can be an LLM integrated with one or more of several other types of models including a convolutional neural network (CNN), a recurrent neural network (RNN), and a visual language model (VLM) or CV.

AI model planner 60 can accept a set of images from target environment 62 and can analyze target environment 62 from the input using several techniques. These techniques include metadata of the images, human description of the input, using a vision-language model, such as Contrastive Language-Image Pre-Training Score (CLIP) or Bootstrapping Language-Image Pre-Training Score (BLIP), a text description of the images from a pre-trained foundational VLM, and a pretrained dictionary (learned from vast amount of datasets available on the internet or other sources). CLIP measures the semantic alignment of images and corresponding texts. BLIP is the similarity between a given image and text pair, which is computed using learned multimodal embedding space. Once AI model planner 60 determines target environment 62, AI modules 54 can be adapted for relevance to target environment 62.

For example, if AI model planner 60 determines that target environment 62 includes aerial images, then deploying detectors, visual question answering (VQA), segmentation, or any task AI module 54 that is learned from the aerial image can be appropriate. This can improve the performance of agentic AI model 64 on target environment 62. AI model 64 can use the documentation available in each AI module 54 to determine the environment from which AI module 54 was trained. The documentation can be publicly accessible, privately derived, or proprietary information.

In another embodiment of the present invention, AI model planner 60 can adjust AI model hyperparameters 56 of the LLM. In some cases, larger AI models 64 yield higher performance but operate slower, while smaller AI models 64 are more efficient but lack the ability to capture complex patterns, leading to lower performance. Selecting the right AI model 64 is a performance-complexity/timeliness trade-off. Agentic AI model 64 can include several different AI modules 54 that can handle the performance of a task based on the requirements of target environment 62.

In an embodiment of the present invention, agentic AI model 64 accepts a set of images from target environment 62. The model can analyze data from the input using several techniques including from metadata of the images, from human description of the input, e.g., from the user preference of inference time requirements, and from customer type (subscription information). Alternatively, the user can imply the execution time requirements or AI model planner 60 can infer the requirements. In some instances, the requirements can be preferences while in other embodiments of the present invention the requirements are necessary.

Once AI model planner 60 determines target application requirements, e.g. execution time (run-time), AI model planner 60 can determine the complexity of the user instructions, and AI modules 54 and AI module 54 settings needed for executing the task such that the requirements are satisfied.

AI model 64 can use the documentation available in each AI module 54 to determine information related to the inquiry, such as the total time needed for the inference. AI model planner 60 can also maintain a dictionary or look-up table that maps user instruction-type (AI model plan 66 embeddings) with inference time, so the information can be retrieved without actually generating the plan. Similarly, for applications where performance accuracy is preferred, as determined by AI model planner 60, AI model 64 can generate plans with more contingencies. For example, using larger AI model 64 and multiple AI models 64 or ensembles to generate the result and then validate the result using other AI modules 54 or heuristics or known solutions. In other embodiments, the contingencies can include multiple means to generate a solution.

Framework 50 can be a form of reinforcement learning (RL) that applies a binary reward leveraging existing datasets. This format allows framework 50 to ignore human preferences and transfer to other datasets.

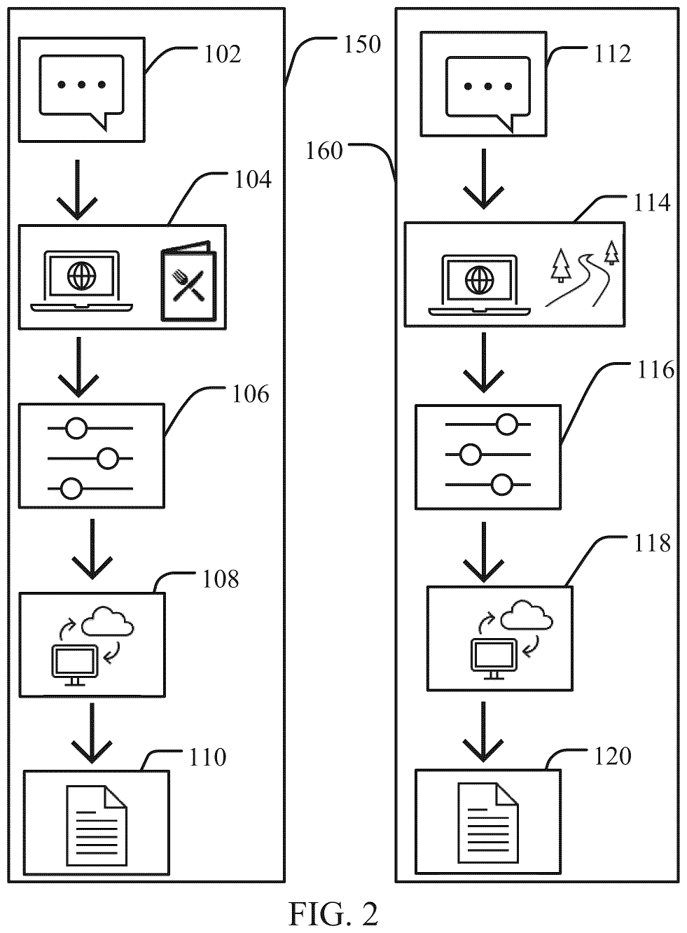

Now referring to FIG. 2, a block diagram illustrates variation in hyperparameters, in accordance with an embodiment of the present invention. First portion 150 demonstrates a use case for restaurant recommendations while a second portion 160 demonstrates a use case for navigation. Prompt 102 can be a question or command. Prompt 102 can be in natural language to direct LLM 104 to a specific domain such as “accommodations” or “reservations.” Prompt 102 is received by LLM 104 which identifies the appropriate domain. For example, given prompt 102, “give me recommendations for good Thai food in Hell's Kitchen,” LLM 104 can identify a domain “concierge.” Based off the domain identified by LLM 104 from prompt 102, hyperparameters 106 can be set accordingly. In an embodiment of the present invention, timely recommendations can be provided responsive from prompt 102. LLM 104 may not provide the most precise recommendations as a compromise for more timely outputs 110 (e.g., reduced execution time). For instance, the recommendations can vary as much as recommending Vietnamese restaurants in Hell's Kitchen or Thai restaurants in the West Village. Modules 108 can then compute these recommendations and generate output 110 to which the user can view.

Prompt 112 can be more involved or incorporate a more precise output 120 than prompt 102. If prompt 112, instead of being directed towards restaurant recommendations, is instead “navigate a scenic driving route from Palm Beach to the Washington Monument.” LLM 114 has a more involved task. LLM 114 has to weigh some efficiency that comes from driving on interstate highways with the opportunity to view the coastline. Another additional consideration can be: what is scenic, etc.? LLM 114 can weigh coastal scenes with forested areas like state and national parks and the time of year the trip is for. The response time of LLM 114 can be expected to be longer to account for the additional complexities of prompt 112. Based on the domain identified by LLM 114 which can be determined to be “travel” or “navigation,” hyperparameters 116 can be different than those of hyperparameters 106 in first portion 150. Module 118 can be the same as module 108. Output 120 generated by LLM 114 can reflect the complexity of prompt 112 as compared to prompt 102.

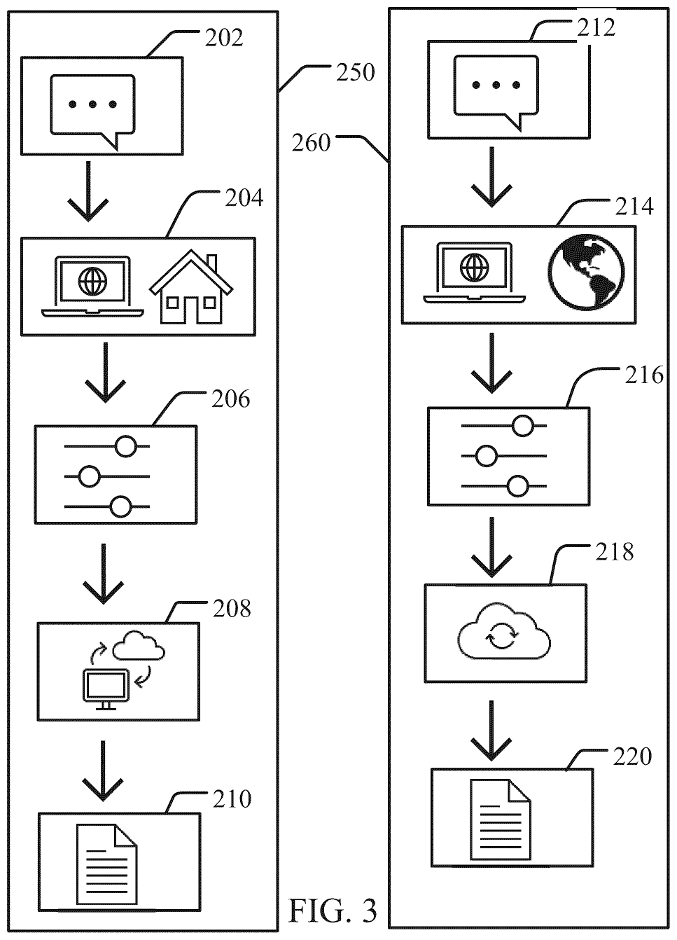

Now referring to FIG. 3, a block diagram illustrating variation in the modules is provided, in accordance with an embodiment of the present invention. Similar to FIG. 2 prompt 202 and prompt 212 have similarities but have enough differences that AI model 64 can be optimized with changes to AI modules 54. Prompt 202, which is in a third portion 250, can ask “identify houses from the street view.” Based off prompt 202, LLM 204 can identify the domain as “front images.” Using the domain, hyperparameters 206 are determined. Then, module 208 can be selected, and LLM 204 can generate output 210.

Contrasting prompt 202, prompt 212, which is in a fourth portion 260, can be “identify houses from above.” Based on prompt 212, LLM 214 can identify the appropriate domain to be “aerial images.” The task according to prompt 212 is the same as the task for that of prompt 202 so hyperparameters 216 can be the same as those for hyperparameters 206. Since the domain is different than that of the domain for prompt 202, module 218 can be different from module 208. Module 208 can have data from street view and module 218 can have data from aerial view. Output 220 can be generated from LLM 114 according to the domain.

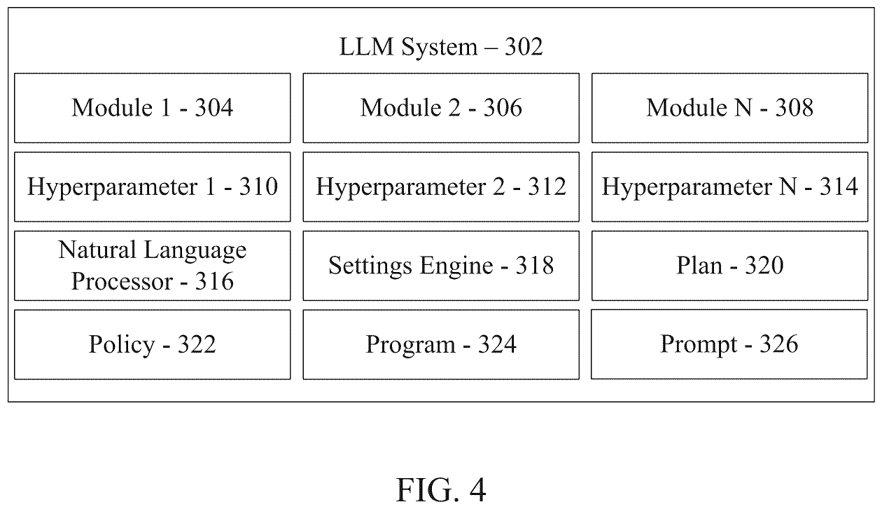

Now referring to FIG. 4, a block diagram of an LLM is shown in greater detail. LLM system 302 can be the same as LLM 104, LLM 114, LLM 204, and/or LLM 214. LLM system 302 can include a natural language processor 316, settings engine 318 and a plethora of modules 304, 306, 308 and hyperparameters 310, 312, 314. The modules can be module1 304, module2 306, until eventually reaching moduleN 316. Similarly, LLM system 302 can have hyperparameter1 310, hyperparameter2 312, until eventually reaching hyperparameterN 314. Natural language processor 316 can communicate with settings engine 318 to identify domains and parameters that most effectively correspond to an input into LLM system 302.

Natural language processor 316 can process user text which then can be in the form of prompt 326. Prompts 326 are used in settings engine 318 to select the appropriate module and hyperparameter settings to adequately respond to the input. The input domain or execution time can be determined by embeddings of the input determined by natural language processor 316. Embeddings can be defined as learned representations of data in a high-level vector space.

Settings engine 318 can then interpret the embeddings from natural language processor 316 to form a plan 320. LLM system 302 can be a black-box LLM that receives prompts 326 as inputs and generates code. In some embodiments of the present invention the generated code can include Python though other embodiments can use any language, such as, e.g., Ruby, Julia, Groovy, Perl, PHP, JavaScript, Java, Scala, Rust, Go, etc. In some embodiments the present invention, changes to the LLM system 302 are initiated through prompts 326. Domains can be added through initiating natural language processor 316 with prompts 326. In alternative embodiments of the present invention, LLM system 302 can be modified by parsing the code generated with more appropriate domains, modules 304, 306, 308, hyperparameters 310, 312, 314, and parameters.

Plan 320 can determine the appropriate modules 304, 306, 308 and hyperparameters 310, 312, 314. In some embodiments of the present invention, plan 320 can also include adjusting parameters. Plan 320 can be a function of the execution time and domain that were identified in the embeddings by natural language processor 316. The execution time can be found in metadata or be related to metadata. Other ways to determine execution time can be GPS location, user description, customer type, etc. Domains can be found in meta data, large-vision language models or user description, etc.

In some embodiments of the present invention, plan 320 can be modified by a human. LLM system 302 can prompt the user for more information or context to form plan 320 if the original prompts 326 is too ambiguous. In other embodiments of the present invention, plan 320 can be modified by a human if LLM system 302 fails to consider a portion of prompts 326.

Policy 322 can be defined as a rule or mapping of states to actions. Program 324 can be defined as a sequence of instructions that can execute policy 322. Plan 320 can be defined as providing the objective policy 322 can be set out to achieve.

Settings engine 318 can generate program 324 that calls modules (tools) trained in the relevant domain by utilizing documentation for optimal performance for the circumstances. Settings engine 318 can also determine the desired execution time and select modules to maximize accuracy based on the total budget of execution time. The execution time can be determined by referencing documentation on modules 304, 306, 308. In some embodiments of the present invention, settings engine 318 can assume the average execution time from each module 304, 306, 308 as the execution time of the given module 304, 306, 308. These execution times can be parameters of the tools to consider the speed accuracy trade-off.

For example, a multi-modal LLM system 302 inference speed can be increased by reducing the output tokens. LLM system 302 then applies plan 320 to provide an output. LLM system 302 integrated with embodiments of the present invention can be agentic for use in a variety of situations and can be improved regularly. LLM system 302 can generate plan 320 which then executes the code in a Python or a sandbox environment.

Modules 304, 306, 308 can include a tokenizer, embedding layer, attention mechanism, decoder block, output head, etc. LLMs systems 302 can employ modules such as GPT models, autoencoders, encoder-decoders, chat and instruction tuned models, multi-modal models, etc. or proprietary models. Modules 304, 306, 308 used can be popular third-party applications e.g., Chat-GPT® or WolframAlpha®. The settings engine 318 can determine an appropriate allocation of execution time and accuracy for a given task to suit prompt 326. The tradeoff of execution time and accuracy weighs both factors against one another. In an embodiment of the present invention, the execution time is inversely proportional to the accuracy.

The pipeline for LLM system 302 can be described by the pseudocode:

```
    meta_data ← ExtractMetaData(Image, Prompt, input_request). # User provided data
    vlm_score ← ComputeVLMScore(Image). # Compare with text embeddings of domain-
names
    vlm_text_desc ← GetVLMTextDescription(Image) # Get description of the image
    dict_domain match ← Match ToPretrainedDictonary(vlm_text_desc, meta_data) #
Compare description with pre-defined embeddings of the domain-names
    parsed_desc ← ParseUserDescription(Prompt) # Parse user prompt to obtain domain info
    if parsed_desc ≠ None then
          target_domain ← parsed_desc
    else if meta_data indicates a domain then
          target_domain ← meta_data.domain
    else if dict_domain_match ≠ None then
          target_domain ← dict_domain_match
    else if vlm_score or vlm_text_desc matches known domain then
          target_domain ← InferDomainFromVLM(vlm_score, vlm_text_desc)
    else
          target_domain ← “natural image domain”
    generated_code = LLM_Agent(Image, Prompt, domain=target_domain) #LLM generates
the code
    for each module m in selected_modules do # parse the code and assign optimal parameters/
thresholds for each module
          params ← LookupOptimalParameters(m, ′target_domain)
          m.set_parameters (params)
    Result = Execute(generated_code)
    return Result
```

The algorithm for selecting LLM system 302 model type and parameters (e.g. determining the execution time tradeoff) can be described by the pseudocode:

```
    MODEL_LIST = [...] # List of all models
    SAFETY_CRITICAL_APPLICATIONS = [‘Driving data analysis’, ‘Insurance analysis’,
‘Forensic Analysis’, ... ] # Analysis applications that require accurate results
    OTHER_APPLICATIONS = [‘Social media’, ‘Tourism’, ... ] # Applications where
immediate responses are important for user experience, even if they are not perfectly accurate
    if meta_data indicates application ∈ SAFETY_CRITICAL_APPLICATIONS then
          MODEL_SIZE = ‘Large’
    else if meta_data indicates application ∈ OTHER APPLICATIONS then
          MODEL_SIZE = ‘Small’
    else if USER_HISTOR available then
          MODEL_SIZE ← lnferApplicationFromHistory(USER_HISTORY) # either
    ‘Large’, ‘Small’, ‘Medium’
    else if APP_TO_RUNTIME_DICT available then
          MODEL_SIZE ← LookupApplication(APP_TO_RUNTIME_DICT) # either
    ‘Large’, ‘Small’, ‘Medium’
    else
          MODEL_SIZE = ‘Medium’ # medium (speed-accuracy tradeoff)
    generated_code = LLM_Agent(Image, Prompt, model_size=MODEL_SIZE). # LLM
generates the code
    for each module m in selected_modules do # parse the code and assign optimal
parameters/thresholds
          params ← LookupOptimalParameters(m, target_domain, MODEL_SIZE)
          m.set_parameters(params)
    Result = Execute(generated_code)
    return Result
```

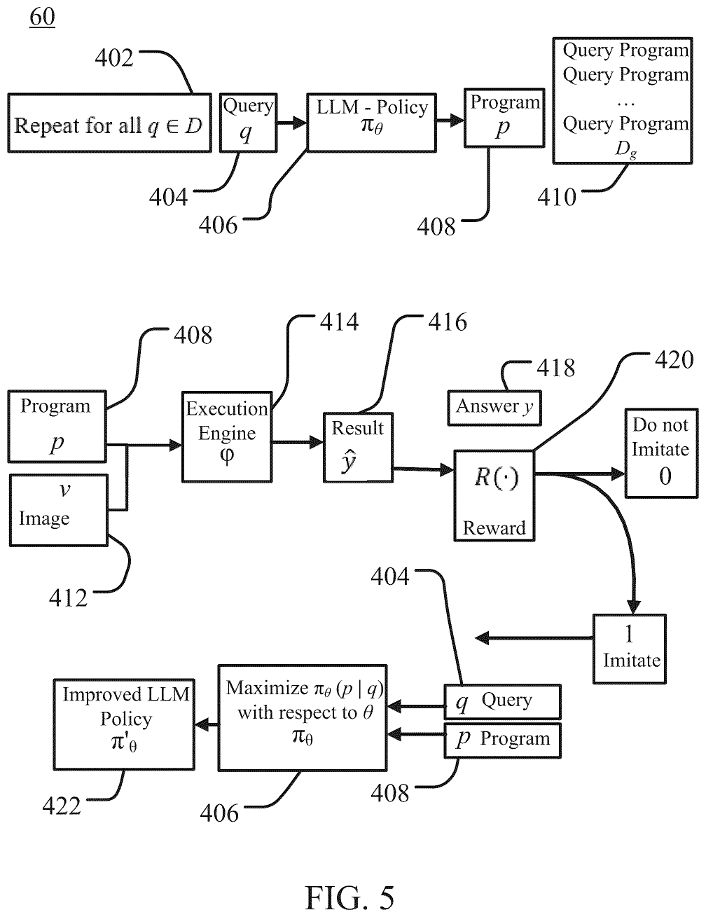

Now referring to FIG. 5, planner 60 for an agentic textual-visual identification model is illustrated, in accordance with an embodiment of the present invention. A self-training LLM can apply visual program synthesis for computer vision tasks using LLM reasoning abilities. Complex visual queries 404 can be executed by decomposing the queries 404 into simpler subtasks. The subtasks can then be performed by perception modules such as e.g., object detection captioning, etc.

In an embodiment of the present invention, the agentic textual-visual identification model can employ the AI model planner 60 to identify appropriate parts for manufacturing a widget. For example, the text can identify the type of widget to be manufactured, the importance of selecting the optimal component, and considerations that are important such as size and cost. In other embodiments, programming CV can be used facilitated by prompting the AI model 64 (FIG. 1) instead of manually coding the desired object detection. This may save time coding/configuring the CV model and prevent the user from accidentally making the model too broad or narrow.

These subtasks can be identified by AI model planner 60 and optimized by incorporating interactive feedback from a generic visual task. The feedback that AI model planner 60 uses can be in the form of reinforcement learning or a reward model 420 such as a coarse reward. In an embodiment of the present invention, the coarse reward model 420 can apply reinforced self-training by treating the language model as a policy 406 and train the policy 406 with a policy 406 gradient.

The reward function can include forming a dataset of synthetic data 410 and optimizing the policy 406 with the synthetic dataset 410 by comparing it to dataset 402. This can improve the language model policy 406 by identifying policies that are effective at achieving a result 416 that is the same as the ground answer 418 (ŷ). AI model planner 60 can then apply this training in new domains and situations after learning improved combinations of AI model hyperparameters 56 (FIG. 1) and AI modules 54 (FIG. 1). The highest reward or most applicable combination can be applied in the future when the reward function is fine-grained.

AI model planner 60 can select and adjust AI model parameters 52, AI modules 54, and AI model hyperparameters 56 to optimize AI model 64 for a variety of tasks, e.g., synthesized visual programs. The optimization can result from feedback from the LLM system 302 (FIG. 4) execution environment. A visually reinforced synthesis program can be incorporated to employ reinforced self-training of the LLM system 302 while the LLM system 302 is offline (FIG. 4). The visually reinforced synthesis program can be model agnostic and use existing vision-language annotations with a policy gradient algorithm. Embodiments of the present invention can include coarse rewards in reinforcement learning. Other embodiments of the present invention can include fine-grained rewards. Fine-grained rewards include applying rewards during each portion of the LLM system 302 (FIG. 4) instead of once at the output result.

One embodiment of the present invention employs a visual program synthesis for improving AI model 64 (FIG. 1). Dataset 402 (D) for vision-language task learning can be defined as D={(v₁, q₁, y₁), . . . (vₙ, qₙ, yₙ)}, where (v) is an image 412, (q) is a textual query 404 and (y) is the ground-truth 418. The values (v), (q), and (y) can form a string for VQA, or bounding boxes for object detection.

Policy 406 (π_{θ}) can use an auto-regressive LLM defined as

$${π}_{θ} ( y \vert x ) = {\prod }_{t = 1}^{T} {π}_{θ} ( {p}_{t} \vert {p}_{1 : t - 1} , x )$$

to learn dataset 402. Policy 406 uses queries 404 from dataset 402 and produces a synthesized program 408. Program 408 is defined as p=π_{θ}(q), where p_{1:t} is defined as the tokens of the program 408, (x) as the input, and θ as the AI model parameters 52. Several queries 404 from dataset 402 can be entered into policy 406 to build synthetic dataset 410 (D_{g}). Synthetic dataset 410 includes trajectories generated by sampling many programs 408 (p) from the current policy π_{θ}:p˜π_{θ}(p|q) for q˜D.

AI model 64 (FIG. 1) can be improved by alternating sampling programs 408, e.g. trajectories from the AI model 64 represented as synthetic dataset 410 D_{g}, with applying behavioral cloning, e.g., using a reward-weighted negative log likelihood loss function 420 (R). The sampling can correspond to the acting step in reinforcement learning and the synthetic dataset 410 generation can correspond to the data gathering step. The behavioral cloning includes inputting program 408 and image 412 into an execution engine 416 φ defined as ŷ=φ(v, p), where ŷ is the result 416 from execution engine 414. AI model 64 (FIG. 1) can be optimized by a policy gradient method, such as, e.g., REINFORCE. In some embodiments of the present invention, the coarse discrete reward function 420 can be defined as existing annotations from a vision-language task.

Policy 406, and AI model 64 (FIG. 1), can be improved by defining a binary-valued reward function 420, where (R):(p),(v),(y)→{0,1}. The policy 406 can then become improved policy 422 (π′_{θ}).

In further detail, execution engine 414 can have a synthetic dataset 410 generation and policy 406 improvement stages. The synthetic dataset 410 generation applies generated code for each textual query 404 to frozen policy 406. If execution engine 414 results in execution engine 416 being the same as ground-truth 418 then the program 408 generated from the code exemplifying policy 406 is saved and added to a preferred dataset. If execution engine 414 and ground-truth 418 are not the same, the code to generate program 408 is discarded. In embodiments employing fine-grained rewards, the portions that incorrect are discarded and portions are correct (compared to e.g., ground-truth 418) are saved and added to a preferred dataset.

Reward function 420, operates by returning an indication to imitate which is represented by the value (1) or an indication not to imitate which is represented by the value (0). Reward function 420 receives values from execution engine 414 and returns result 416 which is an output compared to a ground label 418. If imitation is indicated, query 404 and program 408 are input into policy 406 to maximize π_{θ}(p|q) with respect to θ to generate improved policy 422. Execution engine 414 is a function of program 408 and image 412. Behavioral cloning can be applied to minimize the reward-weighted loss according to

$$J ( θ ) = {𝔼}_{( q , p ) ∼ {D}_{g}}^{′} [ R ( v , p ) L ( p , q ; θ ) ] ,$$

where L(p, q; θ) is the negative log-likelihood loss.

The negative log-likelihood loss can be defined as

$${L}_{NLL} ( p , q ; θ ) = - {𝔼}_{( q , p ) ∼ {D}_{g}} [ {\sum }_{t = 1}^{T} log {π}_{θ} ( {p}_{t} \vert {p}_{1 : t - 1} , q ) ] .$$

This can be implemented with several modifications to reflect the reward function's 418 binary characteristics. Synthetic dataset 410 can be defined as D_{g}={π_{θ}(q):∀∈D}. Synthetic dataset 410 can then be filtered to improve synthetic dataset 410 such that the dataset include D′_{g}={(q, v, p)∈D_{g}:R(q, v, p)>0}. After synthetic dataset 410 is improved, policy 406 can be finetuned on synthetic dataset 410 using a variety of methods. These methods can include standard casual language modeling loss, KL-regularized loss, proximal policy optimization (PPO), direct preference optimization (DPO), reward models with human feedback, contrastive losses, span corruption and masked LM loss, unlikelihood training, minimum risk training (MRT), and entropy-regularized or diversity-promoting loss. Execution engine 414 can act as AI model planner 60 (FIG. 1) by determining which AI modules 54 and AI model hyperparameters 56 (FIG. 1) derive accurate answers for the for a given textual query 404, e.g., prompt 326 (FIG. 4).

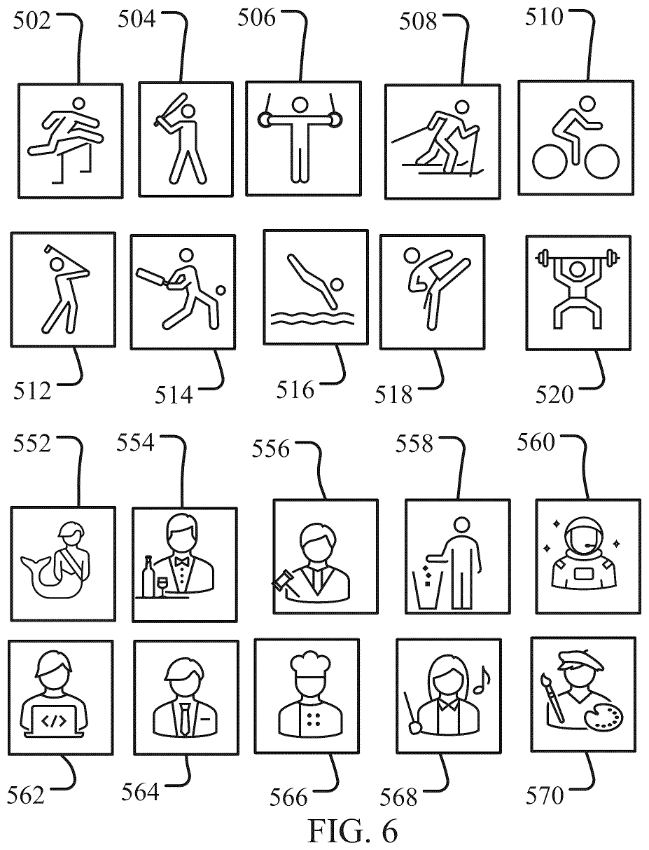

Now referring to FIG. 6, a block diagram is shown for a system that improves LLM system 302 (FIG. 4) using a reward 420 (FIG. 5) is provided, in accordance with an embodiment of the present invention. There can be several training images 412 (FIG. 5), some that are related to the subject that is intended to train the LLM system 302 (FIG. 4). The training images can be a track image 502, a baseball image 504, a gymnastics image 506, a skiing image 508, a cycling image 510, a mermaid image 552, a waiter image 554, a judge image 556, a garbage image 558, and an astronaut image 560. Some of these images are related to the subject of physical exercise while some of them are not. Track image 502, baseball image 504, gymnastics image 506, skiing image 508, and cycling image 510 are directed towards exercise and can train LLM system 302 (FIG. 4) to identify exercises in images along with the prompt “identify people doing sports.” LLM system 302 (FIG. 4) can receive a reward for identifying those images as exercises. The reward will not be given for identifying the mermaid image 552, waiter image 554, judge image 556, garbage image 558, and astronaut image 560 as exercises. LLM system 302 (FIG. 4) can be modeled to imitate policy 406 (FIG. 5) that receives a reward and not imitate policy 406 (FIG. 5) that has not received a reward.

LLM system 302 (FIG. 4) can be tested on additional images. The additional images include a golf image 512, a cricket image 514, a swimming image 516, a martial arts image 518, a lifting image 520, a coding image 562, a corporate image 564, a chef image 566, a conductor image 568, and an artist image 570. When LLM system 302 (FIG. 4) identifies golf image 512, cricket image 514, swimming image 516, martial arts image 518, and lifting image 520 as exercises, there is some degree of certainty that LLM system 302 (FIG. 4) has successfully associated prompt 326 (FIG. 4) with the image 412 (FIG. 5). If LLM system 302 (FIG.) identifies coding image 562, corporate image 564, chef image 566, conductor image 568, and artist image 570 as exercises, then LLM system 302 (FIG. 4) has not properly associated images 412 with prompt 326 (FIG. 4), and policy 406 (FIG. 5) can still be improved.

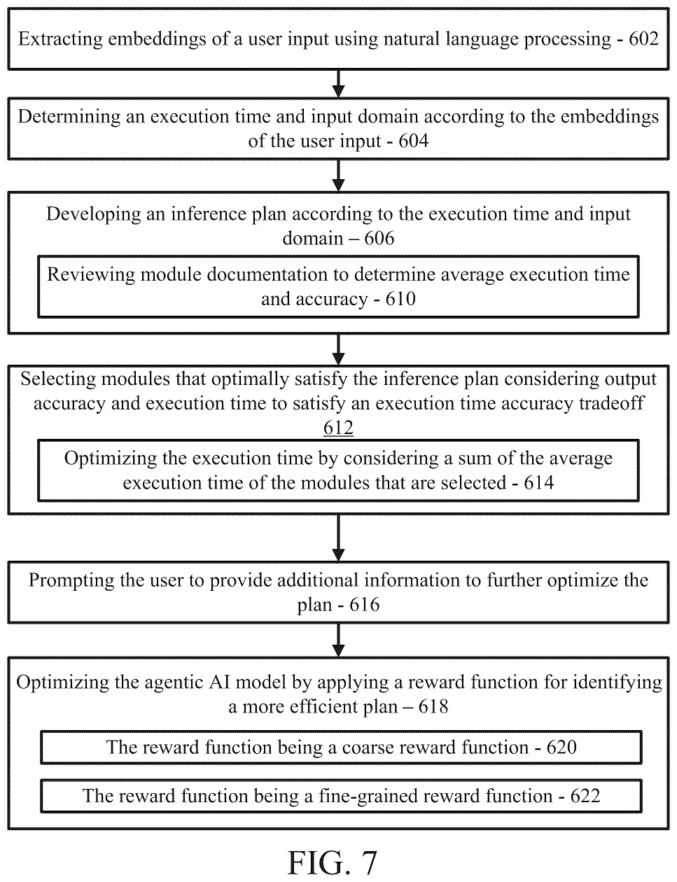

Now referring to FIG. 7, a flow diagram depicting a method for adjusting model parameters is shown, in accordance with an embodiment of the present invention. In block 602, embeddings of user input in the form of natural language are extracted. In block 604, based on the embeddings, the execution time and input domain can be determined. In block 606, the inference plan 320 (FIG. 4) is developed according to the execution time and input domain. In block 610, AI modules 54 (FIG. 1) can determine the average execution time and accuracy of AI modules 54 by reviewing documentation. In block 612, modules 54 (FIG. 1) that adequately satisfy the input domain for execution time and accuracy can be selected. In block 614, the execution time can be optimized by summing the average execution time of modules 54 (FIG. 1) selected. In block 616, the user is prompted to provide additional information. In block 618, AI model 64 (FIG. 1) is optimized by applying a reward function 420 (FIG. 5) for identifying a more efficient plan 320 (FIG. 4). In block 620, the reward function can be a coarse reward function. In block 622, the reward function can be a fine-grained reward function.

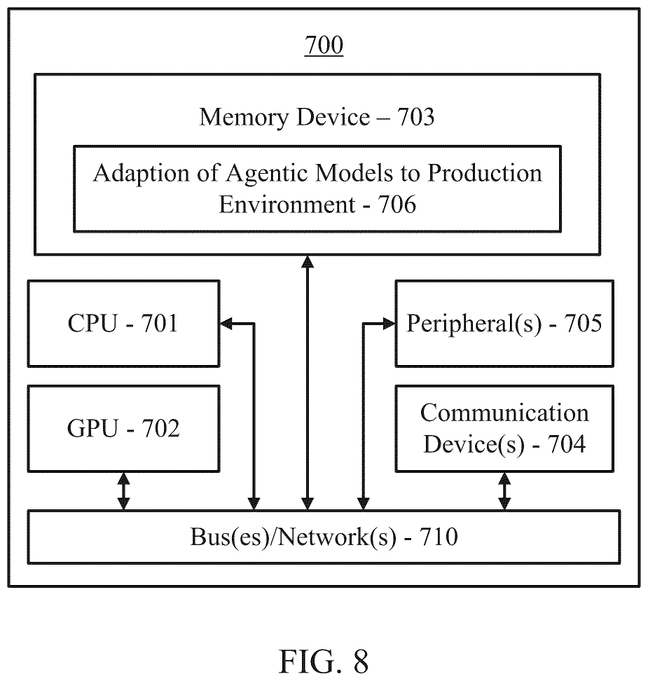

Referring to FIG. 8, a block diagram is shown for an exemplary processing system 600, in accordance with an embodiment of the present invention. The processing system 600 includes a set of processing units (e.g., CPUs) 701, a set of GPUs 702, a set of memory devices 703, a set of communication devices 704, and a set of peripherals 705. The CPUs 701 can be single or multi-core CPUs. The GPUs 702 can be single or multi-core GPUs. The one or more memory devices 703 can include caches, RAMs, ROMs, and other memories (flash, optical, magnetic, etc.). The communication devices 704 can include wireless and/or wired communication devices (e.g., network (e.g., Wi-Fi®, etc.) adapters, etc.). The peripherals 705 can include a display device, a user input device, a printer, an imaging device, and so forth. Elements of processing system 700 are connected by one or more buses or networks (collectively denoted by the figure reference numeral 710).

In an embodiment, memory devices 703 can store specially programmed software modules to transform the computer processing system into a special purpose computer configured to implement various embodiments of the present invention. In an embodiment, special purpose hardware (e.g., Application Specific Integrated Circuits, Field Programmable Gate Arrays (FPGAs), and so forth) can be used to implement various embodiments of the present invention.

In an embodiment, memory devices 703 store program code or software 706 for adaptation of agentic models to production environment. The software 706 can include extracting embeddings of a user input using natural language processing, determining an execution time and input domain according to the embeddings of the user input, developing an inference plan according to the execution time and input domain, and selecting modules that optimally satisfy the inference plan considering output accuracy and execution time to satisfy an execution time accuracy tradeoff. The memory devices 703 can store program code for implementing one or more functions of the systems and methods described herein.

Of course, the processing system 700 may also include other elements (not shown), as readily contemplated by one of skill in the art, as well as omitting certain elements. For example, various other input devices and/or output devices can be included in processing system 700, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 700 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 700.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

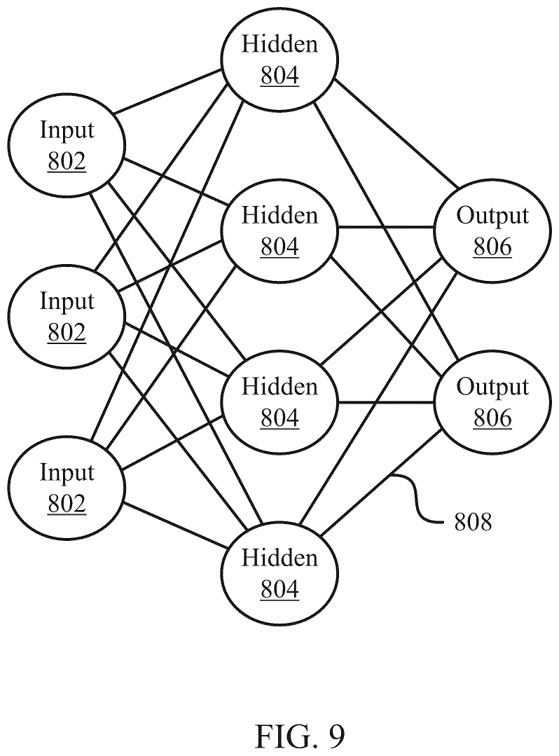

Referring now to FIG. 9, a generalized diagram of a neural network is shown, in accordance with an embodiment of the present invention. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

An artificial neural network (ANN) is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

ANNs demonstrate an ability to derive meaning from complicated or imprecise data and can be used to extract patterns and detect trends that are too complex to be detected by humans or other computer-based systems. The structure of a neural network is known generally to have input neurons 802 that provide information to one or more “hidden” neurons 804. Connections 808 between the input neurons 802 and hidden neurons 804 are weighted, and these weighted inputs are then processed by the hidden neurons 804 according to some function in the hidden neurons 804. There can be any number of layers of hidden neurons 804, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 806 accepts and processes weighted input from the last set of hidden neurons 804.

The parameters of the LLM can be represented by ANN connections 808 weights that can be adjusted through the AI model planner 60 (FIG. 1). The AI modules 54 selected by the AI model planner 60 (FIG. 1) can be represented by either the input neurons 802, the hidden neurons 804, or the output neurons 806. The modules can external and called by the AI model 64 (FIG. 1). Different potential uses can include identifying who is at fault in a traffic accident, identifying safety violations, identifying missing ingredients to a recipe.

This represents a “feed-forward” computation, where information propagates from input neurons 802 to the output neurons 806. Upon completion of a feed-forward computation, the output is compared to a desired output available from training data. The error relative to the training data is then processed in “backpropagation” computation, where the hidden neurons 804 and input neurons 802 receive information regarding the error propagating backward from the output neurons 806. Once the backward error propagation has been completed, weight updates are performed, with the weighted connections 808 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weighted connection 808 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs.

Embodiments described herein may be entirely hardware, entirely software or including both hardware and software elements. In a preferred embodiment, the present invention is implemented in software, which includes but is not limited to firmware, resident software, microcode, etc.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for adapting an agentic artificial intelligence (AI) model:
extracting embeddings of a user input;
determining an execution time and input domain according to the embeddings of the user input;
developing an inference plan according to the execution time and input domain; and
selecting modules that satisfy the inference plan considering output accuracy and execution time to satisfy an execution time accuracy tradeoff.

2. The method of claim 1, wherein the execution time is optimized by considering a total of a sum of an average execution time of the modules that are selected.

3. The method of claim 2, wherein the agentic AI model reviews module documentation to determine average execution time and accuracy.

4. The method of claim 1, further comprising:
prompting the user to provide additional information to further optimize the plan.

5. The method of claim 1, further comprising:
optimizing the agentic AI model by applying a reward function to increase plan efficiency.

6. The method of claim 5, wherein the reward function is a coarse reward function.

7. The method of claim 5, wherein the reward function is a fine-grained reward function.

8. A system for adapting an agentic artificial intelligence (AI) model:
a processor; and
a memory storing computer-readable instructions that, when executed by the processor, cause the system to:
extract embeddings of a user input;
determine an execution time and input domain according to the embeddings of the user input;
develop an inference plan according to the execution time and input domain; and
select modules that satisfy the inference plan considering output accuracy and execution time to satisfy an execution time accuracy tradeoff.

9. The system of claim 8, wherein the execution time is optimized by considering a total of a sum of an average execution time of the modules that are selected.

10. The system of claim 9, wherein the agentic AI model reviews module documentation to determine average execution time and accuracy.

11. The system of claim 8, wherein the memory further causes the system to:
prompt the user to provide additional information to further optimize the plan.

12. The system of claim 8, wherein the memory further causes the system to:
optimize the agentic AI model by applying a reward function to increase plan efficiency.

13. The system of claim 12, wherein the reward function is a coarse reward function.

14. The system of claim 12, wherein the reward function is a fine-grained reward function.

15. A computer program product comprising a non-transitory computer-readable storage medium containing computer program code, the computer program code when executed by one or more processors causes the one or more processors to perform operations, the computer program code comprising instructions to:
extract embeddings of a user input to an agentic artificial intelligence (AI) model;
determine an execution time and input domain according to the embeddings of the user input;
develop an inference plan according to the execution time and input domain; and
select modules that satisfy the inference plan considering output accuracy and execution time to satisfy an execution time accuracy tradeoff.

16. The computer program code of claim 15, wherein the execution time is optimized by considering a total of a sum of an average execution time of the modules that are selected.

17. The computer program code of claim 16, wherein the agentic AI model reviews module documentation to determine average execution time and accuracy.

18. The computer program code of claim 15, wherein the computer program code further causes the processors to:
prompt the user to provide additional information to further optimize the plan.

19. The computer program code of claim 15, wherein the computer program code further causes the processors to o:
optimize the agentic AI model by applying a reward function to increase plan efficiency.

20. The computer program code of claim 19, wherein the reward function is a coarse reward function.
